(19) United States
(12) Patent Application Publication
(10) Pub. No.: US 2019/0194472 A1
(43) Pub. Date: Jun. 27, 2019

(54) CURABLE COMPOSITION AND COATING FILM

(71) Applicant: FUJIFILM Corporation, Tokyo (JP)

(72) Inventor: Kiyotaka FUKAGAWA, Ashigarakami-gun (JP)

(73) Assignee: FUJIFILM Corporation, Tokyo (JP)

(21) Appl. No.: 16/289,759

(22) Filed: Mar. 1, 2019

Related U.S. Application Data
(63) Continuation of application No. PCT/JP2017/031515, filed on Sep. 1, 2017.

(30) Foreign Application Priority Data
Sep. 30, 2016 (JP) 2016-193253

(51) Int. Cl. C09D 4/06; C09D 135/04; C09D 7/20; C09D 5/24

(52) U.S. Cl. CPC C09D 4/06; C09D 135/04; G02B 1/14; C09D 5/24; C09D 7/20

(57) ABSTRACT

A curable composition contains at least one polyfunctional compound selected from the group consisting of a compound represented by General Formula (I) and a compound represented by General Formula (II); a π-conjugated polymer; and an organic solvent.

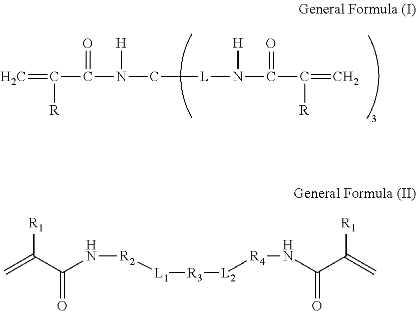

### CROSS-REFERENCE TO RELATED APPLICATIONS

This application is a Continuation of PCT International Application No. PCT/JP2017/031515, filed on Sep. 1, 2017, which claims priority under 35 U.S.C. § 119(a) to Japanese Patent Application No. 2016-193253, filed on Sep. 30, 2016. Each of the above application(s) is hereby expressly incorporated by reference, in its entirety, into the present application.

### BACKGROUND OF THE INVENTION

### 1. Field of the Invention

The present invention relates to a curable composition and a coating film.

### 2. Description of the Related Art

A conductive coating film and an antistatic coating film, each formed of a π-conjugated polymer such as PEDOT/poly(3,4-ethylenedioxythiophene) doped with poly(styrenesulfonic acid) (PSS), are expected to be used in applications displays or electronic elements due to their light weight and flexibility.

For example, JP2014-133787A describes a conductive gel including a gel constituted with a first polymer having a crosslinked network structure and a second polymer which is incorporated into the crosslinked network structure of the first polymer, a conductive polymer which is dispersed in the gel, a dopant, and at least one alkylene glycol-based compound selected from the group consisting of alkylene glycol, alkylene glycol ether, and a polyalkylene glycol having 0 to 4 hydroxyl groups at terminals of the molecular chain, the alkylene glycol-based compound being included in the gel (claim 1). In addition, JP2014-133787A describes uses of N,N′-propylene bisacrylamide and the like for the preparation the first polymer (<0067> to <0068>).

Furthermore, JP2007-031372A discloses a conductive polymer coating material containing a polyfunctional acrylamide monomer and a conductive π-conjugated polymer (claim 3) and a conductive coating film coated with the conductive polymer coating material (claim 4). Further, it is described that the conductive coating film can be suitably used in an antistatic film (paragraph <0070>).

### SUMMARY OF THE INVENTION

With reference to JP2014-133787A, the present inventors have prepared a composition containing N,N′-propylene bisacrylamide, a π-conjugated polymer, and an organic solvent, and have evaluated it, and thus, it became apparent that a coating film obtained from such a composition has deteriorated film hardness and antistatic properties both before and after heating (Comparative Example 3).

In addition, with reference to JP2007-031372A, the present inventors have prepared a composition containing ditrimethylolpropane tetraacrylamide, a π-conjugated polymer, and an organic solvent, and have evaluated it, and thus, it became apparent that after the heating, a coating film obtained from such a composition cannot maintain the film hardness and the antistatic properties before heating (Comparative Example 2).

An object of the present invention is to provide a curable composition which has both high film hardness and excellent antistatic properties, and is used to obtain a coating film capable of maintaining the film hardness and the antistatic properties before and after heating.

In addition, another object of the present invention is to provide a coating film.

The present inventors have conducted extensive studies to solve the problems, and as a result, they have found that a combination of a specific polyfunctional (meth)acrylamide compound and a π-conjugated polymer can be used to solve the problems, thereby leading to the completion of the present invention.

The present invention is based on such knowledge, and specifically to solve the above problems by the following configuration.

[1] A curable composition comprising:
at least one polyfunctional compound selected from the group consisting of a compound represented by General Formula (I) which will be described later and a compound represented by General Formula (II) which will be described later;
a π-conjugated polymer; and
an organic solvent.

[2] The curable composition as described in [1],
in which the π-conjugated polymer is a block copolymer.

[3] The curable composition as described in [2],
in which the block copolymer has a block X of a π-conjugated polymer and a block Y of a polyoxyalkylene.

[4] The curable composition as described in [3],
in which the block copolymer is a block copolymer having one or a plurality of units represented by the block X-the block Y, or a triblock copolymer represented by the block Y-the block X-the block Y.

[5] The curable composition as described in [3] or [4],
in which the block Y is at least one selected from polyethylene glycol or polypropylene glycol.

[6] The curable composition as described in any one of [3] to [5],
in which a terminal of the block Y is an alkyloxy group.

[7] The curable composition as described in any one of [3] to [6],
in which the block X is a doped poly(3,4-ethylenedioxythiophene).

[8] The curable composition as described in any one of [1] to [7],
in which the organic solvent is at least one selected from the group consisting of propylene carbonate, nitromethane, and dichlorobenzene.

[9] The curable composition as described in any one of [1] to [8],
in which the polyfunctional compound is at least one selected from the group consisting of a compound A, a compound B, a compound C, and a compound D, which will be described later.

[10] The curable composition as described in any one of [1] to [9], further comprising an initiator.

[11] The curable composition as described in [10],
in which the content of the polyfunctional compound is 50% to 90% by mass with respect to the total solid content.

[12] A coating film formed by curing the curable composition as described in any one of [1] to [11].

According to the present invention, it is possible to provide a curable composition which has both high film hardness and excellent antistatic properties, and is used to obtain a coating film capable of maintaining the film hardness and the antistatic properties before and after heating; and a coating film formed by curing the curable composition.

### DESCRIPTION OF THE PREFERRED EMBODIMENTS

Hereinafter, the present invention will be described in detail.

In the present specification, a concept of “(meth)acrylamide” includes either or both of acrylamide and methacrylamide, and the same applies to the terms “(meth)acryl” and “(meth)acrylate”. Further, numerical value ranges expressed shown using “to” indicate ranges including the numerical values described before and after “to” as the lower limit values and the upper limit values.

In the present specification, in a case where a plurality of substituents or linking groups (hereinafter referred to as substituents or the like) represented by specific symbols are present or a plurality of substituents or the like are defined at the same time, the respective substituents or the like may be the same as or different from each other. The same also applies to the definition of the number of substituents or the like.

Furthermore, in the present specification, in a case where a group (atomic group) is denoted while not specifying whether it is substituted or unsubstituted, the group (atomic group) includes both a group (atomic group) not having a substituent and a group (atomic group) having a substituent. For example, an “alkyl group” includes not only an alkyl group not having a substituent (unsubstituted alkyl group), but also an alkyl group having a substituent (substituted alkyl group).

In the present specification, for each of the components, a material corresponding to the component can be used singly or in combination of two or more kinds thereof. In a case where the component includes two or more kinds of materials, the content of the component means the total content of the two or more kinds of the materials.

In the present specification, a case where at least one of the film hardness or the antistatic properties of the coating film is more excellent is sometimes mentioned as the effects of the present invention being more excellent.

[Curable Composition]

The curable composition of an embodiment of the present invention (hereinafter also referred to as “the composition of the embodiment of the present invention”) is a curable composition containing at least one polyfunctional compound (polyfunctional (meth)acrylamide compound) selected from the group consisting of a compound represented by General Formula (I) (polyfunctional (meth)acrylamide compound) and a compound represented by General Formula (II) (polyfunctional (meth)acrylamide compound), a π-conjugated polymer, and an organic solvent.

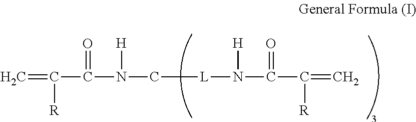

In General Formula (I), R's each independently represent a hydrogen atom or a methyl group, and L's each independently represent —O—, an alkylene group having 2 to 4 carbon atoms, or a divalent linking group formed by combination thereof.

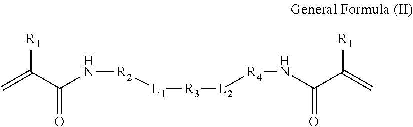

In General Formula (II), R₁'s each independently represent a hydrogen atom or a methyl group, R₂ and R₄ each independently represent —O—, an alkylene group having 1 to 4 carbon atoms, or a divalent linking group formed by combination thereof, R₃ represents —O—, an alkylene group having 2 to 4 carbon atoms, a group represented by General Formula (III), or a divalent linking group formed by combination thereof, and L₁ and L₂ each independently represent a single bond or a group represented b General Formula (III).

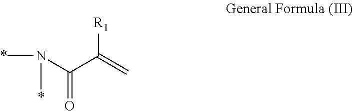

In General Formula (III), R₁ represents a hydrogen atom or a methyl group, and * represents a bonding position.

It is thought that since the composition of the embodiment of the present invention takes such a configuration, the effects can be obtained. A reason therefor is not clear, but is presumed to be approximately as follows.

As described above, in a case where N,N′-propylene bisacrylamide, a π-conjugated polymer, and an organic solvent are mixed to prepare a composition, the film hardness and the antistatic properties of a coating film thus obtained become insufficient (Comparative Example 3). This is caused by a decrease in the solubility of N,N′-propylene bisacrylamide in the organic solvent and a decrease in the uniformity of the coating film, according to a finding obtained upon it.

In addition, in a case where ditrimethylolpropane tetraacrylamide, a π-conjugated polymer, and an organic solvent are mixed to prepare a composition, the film hardness and the antistatic properties of a coating film thus obtained were decreased after heating (Comparative Example 2). This is caused by a decrease in the uniformity of the coating film due to a low solubility of ditrimethylolpropane tetraacrylamide in the organic solvent, and by the structure of ditrimethylolpropane tetraacrylamide itself, according to a finding obtained upon it.

The present invention is based on the findings, and in the present invention, a compound having a high solubility in an organic solvent may be used. That is, since a specific polyfunctional (meth)acrylamide compound and a π-conjugated polymer, each of which will be described later, have a high solubility in an organic solvent, the specific polyfunctional (meth)acrylamide compound and the π-conjugated polymer are compatible in the organic solvent, and as a result, the uniformity of a coating film obtained from the composition of the embodiment of the present invention is extremely high. Further, it is thought that in the composition of the embodiment of the present invention, the film hardness of the entire coating film is increased by uniformly curing the specific polyfunctional (meth)acrylamide compound, and the π-conjugated polymer does not cause significant phase separation from the polyfunctional (meth)acrylamide compound and takes a microstructure in which the π-conjugated polymer is homogeneously dispersed in the entire coating film. As a result, it is thought that since an appropriate conductive path is formed between the π-conjugated polymer chains, the antistatic properties are excellent.

Hereinafter, each of the components contained in the composition of the embodiment of the present invention will be described in detail.

[Polyfunctional (Meth)Acrylamide Compound]

The composition of the embodiment of the present invention contains at least one polyfunctional (meth)acrylamide compound selected from the group consisting of a polyfunctional (meth)acrylamide compound represented by General Formula (I) and a polyfunctional (meth)acrylamide compound represented by General Formula (II).

Furthermore, in the present specification, the polyfunctional (meth)acrylamide compound (polyfunctional compound) in a concept including the polyfunctional (meth)acrylamide compound represented by General Formula (I) and the polyfunctional (meth)acrylamide compound represented by General Formula (II) is also hereinafter referred to as “a specific compound”.

<Polyfunctional (Meth)Acrylamide Compound Represented by General Formula (I)>

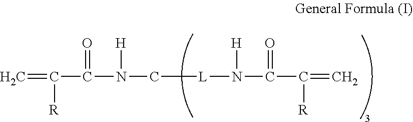

In General Formula (I), R's each independently represent a hydrogen atom or a methyl group.

L's each independently represent —O—, an alkylene group having 2 to 4 carbon atoms, or a divalent linking group formed by combination thereof. At a position adjacent to the nitrogen atom in the amide group adjacent to L, a carbon atom is preferably positioned. That is, as the group adjacent to the nitrogen atom in the amide group, an alkylene group having 2 to 4 carbon atoms is preferably positioned.

Examples of the “divalent linking group formed by combination thereof” include an alkylene group having 2 to 4 carbon atoms, including —O—, such as —OCH₂CH₂—, —OCH₂CH₂CH₂—, —OCH₂CH₂CH₂CH₂—, —CH₂OCH₂—, —CH₂OCH₂CH₂—, and —CH₂OCH₂CH₂CH₂—; and

a group represented by —(O-alkylene group (having 2 to 4 carbon atoms))ₙ— (n represents an integer of 2 or more. An upper limit thereof is not particularly limited, but may be approximately 100).

Among those, from the viewpoint that the effects of the present invention are more excellent, it is preferable that L is an alkylene group having 2 to 4 carbon atoms, including —O—.

<Polyfunctional (Meth)Acrylamide Compound Represented by General Formula (II)>

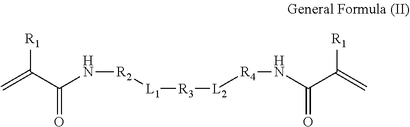

In General Formula (II), R₁'s each independently represent a hydrogen atom or a methyl group.

R₂ and R₄ each independently represent —O—, an alkylene group having 1 to 4 carbon atoms, or a divalent linking group formed by combination thereof. At a position adjacent to the nitrogen atom in the amide group adjacent to R₂ and R₄, a carbon atom is preferably positioned. That is, as the group adjacent to the nitrogen atom in the amide group, an alkylene group having 1 to 4 carbon atoms is preferably positioned.

Examples of the “divalent linking group formed by combination thereof” include an alkylene group having 1 to 4 carbon atoms, including —O—, such as —OCH₂—, —OCH₂CH₂—, —OCH₂CH₂CH₂—, —OCH₂CH₂CH₂CH₂—, —CH₂OCH₂—, —CH₂OCH₂CH₂—, and —CH₂OCH₂CH₂CH₂—; and a group represented by —(O-alkylene group (having 1 to 4 carbon atoms))ₙ— (n represents an integer of 2 or more. An upper limit thereof is not particularly limited, but may be approximately 100). Further, in each of the groups exemplified as the “divalent linking group formed by combination thereof”, any of the two bonding positions may be bonded to the amide group.

Among those, from the viewpoint that the effects of the present invention are more excellent, it is preferable that R₂ and R₄ each independently represent an alkylene group having 1 to 4 carbon atoms or an alkylene group having 1 to 4 carbon atoms, including —O—.

In General Formula (II), R₃ represents —O—, an alkylene group having 2 to 4 carbon atoms, a group represented by General Formula (III), or a divalent linking group formed by combination thereof.

Examples of the “divalent linking group formed by combination thereof” include an alkylene group having 2 to 4 carbon atoms, including —O—, such as —OCH₂CH₂—, —OCH₂CH₂CH₂—, —OCH₂CH₂CH₂CH₂—, —CH₂OCH₂CH₂—, and —CH₂OCH₂CH₂CH₂—; and a group represented by —(O-alkylene group (having 2 to 4 carbon atoms))ₙ- (n represents an integer of 2 or more. An upper limit thereof is not particularly limited, but may be approximately 100). Further, in each of the groups exemplified by the “divalent linking group formed by combination thereof”, any of the two bonding positions may be bonded to the amide group.

In a case where the group represented by General Formula (III) is combined with another group, it is preferable that an alkylene group having 2 to 4 carbon atoms is bonded to the nitrogen atom in the group represented by General Formula (III).

Among those, from the viewpoint that the effects of the present invention are more excellent, it is preferable that R₃ is an alkylene group having 2 to 4 carbon atoms, an alkylene group having 2 to 4 carbon atoms, including —O—, or a group represented by General Formula (III).

L₁ and L₂ each independently represent a single bond or a group represented by General Formula (III).

In a case where R₃ represents General Formula (III), it is preferable that L₁ and L₂ are both a single bond.

(Group Represented by General Formula (III))

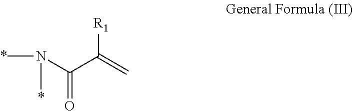

In General Formula (III), R₁ represents a hydrogen atom or a methyl group, and * represents a bonding position. Further, a carbon atom is usually positioned at *.

Specific examples of the polyfunctional (meth)acrylamide compound represented by General Formula (I) or (II) are shown below.

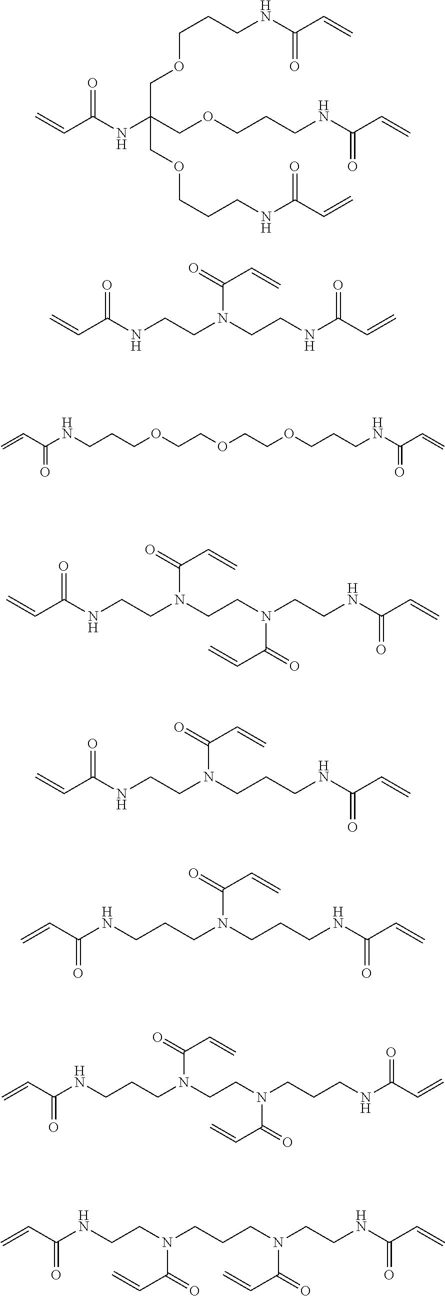

Among those, the specific compound is preferably the compound represented by General Formula (II), and more preferably at least one selected from the group consisting of the following compound A, compound B, compound C, and compound D.

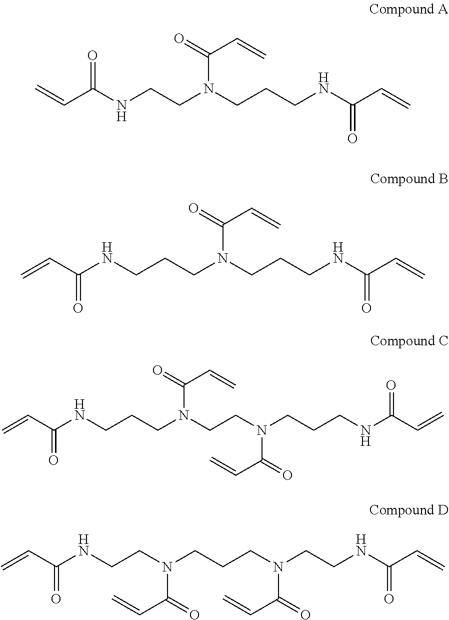

As the specific compound, various commercially available products can be used. Further, the specific compound can be synthesized, for example, by a method described in JP2013-502654A.

[π-Conjugated Polymer]

The π-conjugated polymer is not particularly limited as long as it is an organic polymer whose main chain has a π-conjugated system. Examples of the π-conjugated polymer include polypyrroles, polythiophenes, polyacetylenes, polyphenylenes, polyphenylenevinylenes, polyanilines, polyacenes, polythiophenevinylenes, and copolymers of these. From the viewpoint of ease of polymerization and stability in air, at least one selected from the group consisting of polypyrroles, polythiophenes, and polyanilines is preferable.

Sufficient antistatic properties (or conductivity) and compatibility of the π-conjugated polymer with the specific compound can be obtained even in a case where the π-conjugated polymer remains unsubstituted. However, in order to further improve the antistatic properties (or conductivity) and the compatibility with the specific compound, it is preferable that a functional group such as an alkyl group, a carboxy group, a sulfo group, an alkoxy group, a hydroxyl group, or a cyano group is introduced to the π-conjugated polymer.

Specific examples of the π-conjugated polymer include polypyrrole, poly(N-methylpyrrole), poly(3-methylpyrrole), poly(3-ethylpyrrole), poly(3-n-propylpyrrole), poly(3-butylpyrrole), poly(3-octylpyrrole), poly(3-decylpyrrole), poly(3-dodecylpyrrole), poly(3,4-dimethylpyrrole), poly(3,4-dibutylpyrrole), poly(3-carboxypyrrole), poly(3-methyl-4-carboxypyrrole), poly(3-methyl-4-carboxyethylpyrrole), poly(3-methyl-4-carboxybutylpyrrole), poly(3-hydroxypyrrole), poly(3-methoxypyrrole), poly(3-ethoxypyrrole), poly(3-butoxypyrrole), poly(3-hexyloxypyrrole), poly(3-methyl-4-hexyloxypyrrole), poly(thiophene), poly(3-methylthiophene), poly(3-ethylthiophene), poly(3-propylthiophene), poly(3-butylthiophene), poly(3-hexylthiophene), poly(3-heptylthiophene), poly(3-octylthiophene), poly(3-decylthiophene), poly(3-dodecylthiophene), poly(3-octadecylthiophene), poly(3-bromothiophene), poly(3-chlorothiophene), poly(3-iodothiophene), poly(3-cyanothiophene), poly(3-phenylthiophene), poly(3,4-dimethylthiophene), poly(3,4-dibutylthiophene), poly(3-hydroxythiophene), poly(3-methoxythiophene), poly(3-ethoxythiophene), poly(3-butoxythiophene), poly(3-hexyloxythiophene), poly(3-heptyloxythiophene), poly(3-octyloxythiophene), poly(3-decyloxythiophene), poly(3-dodecyloxythiophene), poly(3-octadecyloxythiophene), poly(3,4-dihydroxythiophene), poly(3,4-dimethoxythiophene), poly(3,4-diethoxythiophene), poly(3,4-dipropoxythiophene), poly(3,4-dibutoxythiophene), poly(3,4-dihexyloxythiophene), poly(3,4-diheptyloxythiophene), poly(3,4-dioctyloxythiophene), poly(3,4-didecyloxythiophene), poly(3,4-didodecyloxythiophene), poly(3,4-ethylenedioxythiophene), poly(3,4-propylenedioxythiophene), poly(3,4-butenedioxythiophene), poly(3-methyl-4-methoxythiophene), poly(3-methyl-4-ethoxythiophene), poly(3-carboxythiophene), poly(3-methyl-4-carboxythiophene), poly(3-methyl-4-carboxyethylthiophene), poly(3-methyl-4-carboxybutylthiophene), polyaniline, poly(2-methylaniline), poly(3-isobutylaniline), poly(2-anilinesulfonic acid), and poly(3-anilinesulfonic acid).

In addition, the π-conjugated polymer may be doped. Here, the expression of the π-conjugated polymer being doped means that the curable composition contains the π-conjugated polymer and a dopant which will be described later.

Among those, polypyrrole, polythiophene, poly(N-methylpyrrole), poly(3-methylthiophene), poly(3-methoxythiophene), or poly(3,4-ethylenedioxythiophene) (PEDOT) is preferable, and doped poly(3,4-ethylenedioxythiophene) (PEDOT) is more preferable.

The dopant to be applied to the π-conjugated polymer is not particularly limited and examples thereof include dopants known in the related art. Specific examples of the dopant include halogen (bromine, iodine, ICI, and IC₃), Lewis acids (PF₅, AsF₅, BF₃, and SO₃), protonic acids (poly(styrenesulfonic acid) (PSS), p-toluenesulfonic acid, perchloric acid, hydrochloric acid, sulfuric acid, and salts thereof), transition metal halides (iron (III) chloride, iron (III) bromide, and tin (IV) chloride), organic dopants (tetracyanoethylene (TCNE), tetracyanoquinodimethane (TCNQ), 2,3-dichloro-5,6-dicyano-p-(DDQ), and amino acid), alkali metals (lithium, sodium, potassium, rubidium, and cesium), and alkaline earth metals (beryllium, magnesium, and calcium). Among those, the protonic acids (poly(styrenesulfonic acid) (PSS), p-toluenesulfonic acid, perchloric acid, and salts thereof) are preferable.

The content of the dopant is preferably 1×10⁻⁴% to 1×10³% by mole, more preferably 1×10⁻³% to 5×10²% by mole, and particularly preferably 1×10⁻²% to 2×10²% by mole, with respect to the π-conjugated polymer.

Furthermore, from the viewpoints that the effects of the present invention are more excellent and the compatibility with the specific compound is excellent, it is preferable that the π-conjugated polymer is a block copolymer.

In a case where the π-conjugated polymer is the block copolymer, it is preferable that the π-conjugated polymer (hereinafter referred to as “a π-conjugated block copolymer”) has a block X of a π-conjugated polymer.

The π-conjugated polymer which can constitute the block X in the π-conjugated block copolymer is not particularly limited as long as it is a π-conjugated polymer. Specific examples thereof include the same ones as the specific examples of the π-conjugated polymer.

Among those, polypyrrole, polythiophene, poly(N-methylpyrrole), poly(3-methylthiophene), poly(3-methoxythiophene), or poly(3,4-ethylenedioxythiophene) (PEDOT) is preferable, and doped poly(3,4-ethylenedioxythiophene) (PEDOT) is more preferable.

Furthermore, the viewpoints that the effects of the present invention are more excellent and the compatibility with the specific compound is excellent, it is preferable that the π-conjugated block copolymer has a block X of the π-conjugated polymer and a block Y of a polyoxyalkylene.

Examples of the π-conjugated block copolymer include a block copolymer having one or a plurality of units, represented by (block X-block Y) and a triblock copolymer represented by (block Y-block X-block Y).

The π-conjugated block copolymer may be either linear or branched. In a case where the π-conjugated block copolymer is branched, one of preferred aspects may be an aspect in which the block X is linear and the block Y is branched.

From the viewpoints that the effects of the present invention are more excellent and the compatibility with the specific compound is excellent, it is preferable that the block Y is at least one selected from polyethylene glycol or polypropylene glycol.

One of preferred aspects may be an aspect in which a terminal of the block Y is an alkyloxy group. That is, it is preferable that a terminal of the block Y is blocked with an alkyloxy group. Examples of the alkyloxy group include C₁₂H₂₅—O—.

From the viewpoints that the effects of the present invention are more excellent and the compatibility with the specific compound is excellent, examples of the π-conjugated block copolymer include a compound represented by Formula a), b), or c).

In Formula a), it is preferable that x, y, and n are each independently an integer of 1 to 1,000.

In Formula b), it is preferable that x and y are each independently an integer of 1 to 1,000.

In Formula c), it is preferable that x and y are each independently an integer of 1 to 1,000.

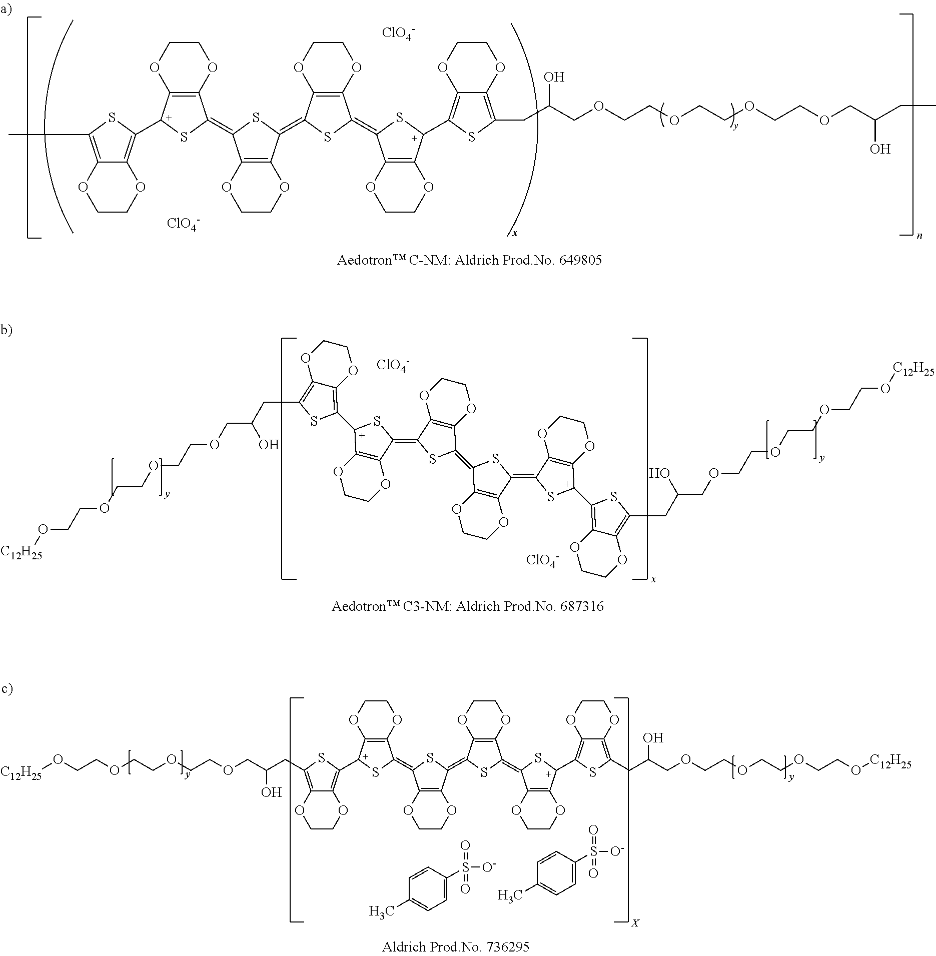

A method for producing the π-conjugated polymer is not particularly limited. Further, as the π-conjugated polymer, a commercially available product can be used.

Examples of the commercially available product of the π-conjugated polymer include Aedotron C3-PC (manufactured by Aldrich, Product No. 736287, a mixture of a π-conjugated polymer and propylene carbonate), and Aedotron P3-NM (manufactured by Aldrich, Product No. 736295, a mixture of a π-conjugated polymer and nitromethyl).

[Organic Solvent]

The organic solvent contained in the composition of the embodiment of the present invention is not particularly limited as long as it can dissolve the specific compound and the π-conjugated polymer.

It is possible to use an ordinary organic solvent as the organic solvent. Among those, a polar aprotic solvent is preferable as the organic solvent from the viewpoints that the effects of the present invention are more excellent and the compatibility of the π-conjugated polymer with the specific compound is excellent. The polar aprotic solvent is a solvent for the organic compound, which has polarity and is free of proton donating properties.

Examples of the organic solvent include esters such as ethyl acetate and n-butyl acetate;

aromatic hydrocarbons such as toluene and benzene;

aliphatic hydrocarbons such as n-hexane and n-heptane;

alicyclic hydrocarbons such as cyclohexane and methylcyclohexane;

ketones such as methyl ethyl ketone (MEK), methyl isobutyl ketone, and cyclohexanone;

alcohols such as methanol and butanol;

di-lower alkylformamides such as N,N-dimethylformamide and N,N-diethylformamide;

di-lower alkyl sulfoxides such as dimethyl sulfoxide, and diethyl sulfoxide;

hexa-lower alkylphosphoryl amides such as hexamethylphosphoryl triamide and hexaethylphosphoryl triamide;

di-lower alkylacetamides such as N,N-dimethylacetamide and N,N-diethylacetamide;

tetra-lower alkyl ureas such as N,N,N′,N′-tetramethyl urea and N,N,N′,N′-tetraethyl urea;

lower alkyl cyanides such as acetonitrile, propionitrile, succinonitrile, butyronitrile, isobutyronitrile, and valeronitrile;

aromatic cyanides such as benzonitrile and α-tolunitrile;

nitro-lower alkanes such as nitromethane, nitroethane, 1-nitropropane, and 2-nitropropane;

aromatic nitro compounds such as nitrobenzene, nitrotoluene, and o-nitroanisole;

cyclic sulfones such as sulfolane and methylsulfolane;

cyclic amides such as N-methylpyrrolidone;

cyclic ureas such as 1,3-dimethyl-2-imidazolidinone;

dichlorobenzene; and

propylene carbonate.

Among those, the organic solvent is preferably at least one polar aprotic solvent selected from the group consisting of di-lower alkylformamide, di-lower alkyl sulfoxide, hexa-lower alkylphosphoryl amide, di-lower alkylacetamide, tetra-lower alkyl urea, lower alkyl cyanide, aromatic cyanide, nitro-lower alkane, aromatic nitro compound, cyclic sulfone, cyclic amide, cyclic urea, dichlorobenzene, and propylene carbonate, from the viewpoints that the effects of the present invention are more excellent and the compatibility of the π-conjugated polymer with the specific compound is excellent.

From the viewpoints that the effects of the present invention are more excellent and the solubility of the specific compound and the π-conjugated polymer is excellent, it is preferable that the organic solvent is at least one selected from the group consisting of propylene carbonate, nitromethane, and dichlorobenzene.

The π-conjugated polymer and the organic solvent may be prepared in advance as a mixture including the π-conjugated polymer and the organic solvent. In this case, the amount of the components other than the organic solvent in the mixture can be set to the amount of the π-conjugated polymer.

(Other Monomers)

The composition of the embodiment of the present invention may further contain monomers (for example, monofunctional monomers) other than the above-described specific compound.

Examples of the monofunctional monomers include a hydroxyl group-containing (meth)acrylate such as 2-hydroxyethyl (meth)acrylate, 2-hydroxypropyl (meth)acrylate, 2-hydroxybutyl (meth)acrylate, 4-hydroxybutyl (meth)acrylate, and glycerin mono(meth)acrylate;
a (meth)acrylic acid and a carboxylate thereof;
a nitrogen atom-containing (meth)acrylate such as dimethylaminoethyl (meth)acrylate, and 2-morpholinoethyl (meth)acrylate;
a (meth)acrylate having an ether bond, such as methoxyethyl (meth)acrylate, 3-methoxybutyl (meth)acrylate, methoxydipropylene glycol (meth)acrylate, methoxytripropylene glycol (meth)acrylate, methoxypolyethylene glycol (meth)acrylate, and phenoxyethyl (meth)acrylate;
a mono(meth)acrylamide compound having one (meth)acrylamide bond in one molecule (provided that it has no hydroxyl group), such as (meth)acrylamide, 2-hydroxyethyl (meth)acrylamide, 2-acrylamide-2-methylpropanesulfonic acid, and a sulfonate thereof;

a hydroxyl group-containing monofunctional (meth)acrylamide compound having one (meth)acrylamide bond in one molecule and a hydroxyl group, such as 2-hydroxyethyl (meth)acrylamide; and

a betaine compound such as N-methacryloyloxyethyl-N,N-dimethylammonium-N-methylcarboxybetaine, 2-(methacryloyloxy)ethyl 2-(trimethylammonio)ethyl phosphate, N-(3-sulfopropyl)-N-(methacryloxyethyl)-N,N-dimethylammonium betaine, and N-(4-sulfobutyl)-N-(methacryloylaminopropyl)-N,N-diammonium betaine.

In a preferred aspect, a monomer other than the specific compound may be a hydroxyl group-containing (meth)acrylate or a hydroxyl group-containing monofunctional (meth)acrylamide compound.

(Initiator)

It is preferable that the composition of the embodiment of the present invention further contains an initiator.

Examples of the initiator include a photopolymerization initiator and a thermal polymerization initiator. Further, the photopolymerization initiator may further have the properties of the thermal polymerization initiator. The thermal polymerization initiator may further the properties of the photopolymerization initiator.

Examples of the photopolymerization initiator include an alkynephenone-based photopolymerization initiator, a methoxyketone-based photopolymerization initiator, an acylphosphine oxide-based photopolymerization initiator, a hydroxyketone-based photopolymerization initiator (such as IRGACURE 184; 1,2-at-hydroxyalkylphenone), an aminoketone-based photopolymerization initiator (such as 2-methyl-1-[4-(methylthio)phenyl]-2-morpholino-propan-1-one (IRGACURE (registered trademark) 907)), an oxime-based photopolymerization initiator, and an oxyphenylacetic ester-based photopolymerization initiator (IRGACURE (registered trademark) 754).

Examples of other initiators include an azo-based polymerization initiator (for example, V-601 manufactured by Wako Pure Chemical Industries, Ltd., a thermal polymerization initiator), a persulfate-based polymerization initiator, a peroxysulfuric acid-based polymerization initiator, and a redox-based polymerization initiator.

In addition, it is preferable that the initiator has the solubility in an organic solvent.

(Total Solid Content)

The total solid content contained in the composition of the embodiment of the present invention is preferably 1% to 60% by mass, and more preferably 1% to 10% by mass, with respect to the total amount of the composition of the embodiment of the present invention.

In the present specification, the solid content is intended to mean components constituting the coating film. The solid content does not include the organic solvent and water. Since the monomer is a component which can constitute the coating film, the monomer is included in the solid content even in a case where it is a liquid.

The specific compound and the π-conjugated polymer are included in the solid content.

In a case where the composition of the embodiment of the present invention further contains an initiator, the initiator is included in the solid content.

In a case where the composition of the embodiment of the present invention further contains such other monomers, the other monomers are included in the solid content.

(Content of Each of Components)

Content of Specific Compound

The content of the specific compound (polyfunctional compound) is preferably 10% to 99% by mass, and more preferably 50% to 90% by mass, with respect to the total solid content.

Content of π-Conjugated Polymer

The content of the π-conjugated polymer is preferably 0.09% to 60% by mass, more preferably 1% to 60% by mass, and still more preferably 3% to 30% by mass, with respect to the total solid content.

Mass Ratio of π-Conjugated Polymer to Specific Compound

The mass ratio of the π-conjugated polymer to the specific compound (π-conjugated polymer/specific compound) is preferably 0.01 to 10, and more preferably 0.1 to 0.95. The numerical value range can be set to the same range even in a case where the composition of the embodiment of the present invention further contains an initiator.

In a case where the composition of the embodiment of the present invention further contains an initiator, the content of the initiator is preferably 0.1% to 10% by mass, and more preferably 1% to 5% by mass, with respect to the total solid content.

In a case where the composition of the embodiment of the present invention further contains an initiator, the content of the initiator is preferably 0.01% to 100% by mass, more preferably 0.1% to 50% by mass, and still more preferably 0.5% to 10% by mass, with respect to the specific compound.

In a case where the composition of the embodiment of the present invention further contains such other monomers, the content of such other monomers can be set to 0% to 50% by mass with respect to the total solid content. In this case, the content of the specific compound can be set to 10% to 90% by mass with respect to the total solid content, and the content of the π-conjugated polymer can be set to 1% to 60% by mass with respect to the total solid content.

(Method for Preparing Curable Composition)

A method for preparing the composition of the embodiment of the present invention is not particularly limited and a known method can be employed. For example, the composition can be prepared by mixing the respective components, followed by stirring by a known means. Specific examples of the method include a method in which a mixture including a π-conjugated polymer and an organic solvent is mixed with a specific compound, and an initiator, other monomers, or the like which can be used as necessary.

[Coating Film]

The coating film of an embodiment of the present invention is a coating film formed by curing the curable composition of the embodiment of the present invention.

The curable composition used in the coating film of the embodiment of the present invention is not particularly limited as long as it is the composition of the embodiment of the present invention.

The film thickness of the coating film of the embodiment of the present invention is not particularly limited, but is preferably 0.1 to 300 μm, and more preferably 1 to 100 μm.

(Method for Producing Coating Film)

A method of producing the coating film of the embodiment of the present invention is not particularly limited, but examples thereof include a method of applying the above-mentioned composition of the embodiment of the present invention onto a base material and curing the composition by heating or irradiating the base material with light (for example, ultraviolet rays, visible light rays, and X-rays).

The base material is not particularly limited, and for example, various plastic base materials can be used. One of preferred aspects may be an aspect in which the base material is transparent.

As the plastic base material, for example, a resin film base material obtained by using polyethylene terephthalate, polybutylene terephthalate, polyethylene naphthalene, polyethylene, polypropylene, cellophane, diacetyl cellulose, triacetyl cellulose, acetyl cellulose butyrate, polyvinyl chloride, polyvinylidene chloride, polyvinyl alcohol, an ethylene-vinyl acetate copolymer, polystyrene, polycarbonate, polymethylpentene, polysulfone, polyether ether ketone, polyether sulfone, polyether imide, polyimide, a fluorine resin, nylon, an acrylic resin, a polyamide, a cycloolefin, or the like can be used. Among these, a film formed of polyethylene terephthalate, polyethylene naphthalate, or the like is preferably used from the viewpoint of further improving the mechanical strength.

The base material may be a base material formed of only a plastic, but may also be a plastic base material which includes a primer layer on a surface thereof for the purpose of further improving the adhesiveness to the coating film.

In addition, for the purpose of improving the adhesiveness to the coating film, the base material may be a base material which has been subjected to a surface treatment such as a surface roughening treatment by a sand blast method, a solvent treatment method, or the like, a corona discharge treatment, a chromic acid treatment, a flame treatment, a hot air treatment, an ozone treatment, an ultraviolet irradiation treatment, and a surface oxidation treatment.

Examples of the method for applying the composition of the embodiment of the present invention include roll coating, kiss roll coating, gravure coating, reverse coating, roll brush coating, spray coating, dip roll coating, bar coating, knife coating, air knife coating, curtain coating, rip coating, and an extrusion coating method by a die coater.

The method of heating the composition of the embodiment of the present invention is not particularly limited, and the composition can be heated using a blast dryer, an oven, an infrared dryer, a heating drum, or the like.

The temperature for heating the composition is not particularly limited, but is preferably 30° C. to 150° C., and more preferably 40° C. to 120° C.

Examples of the method for irradiating the composition of the embodiment of the present invention with light include a method using a low-pressure mercury lamp, a medium-pressure mercury lamp, a high-pressure mercury lamp, a metal halide lamp, deep ultraviolet (Deep-UV) rays, a xenon lamp, a chemical lamp, a carbon arc lamp, or the like. The energy for light irradiation is not particularly limited, but is preferably 0.1 to 10 J/cm². The temperature condition for light irradiation is not particularly limited. The temperature condition for light irradiation can be set to, for example, approximately room temperature.

(Applications)

The coating film of the embodiment of the present invention can be used as, for example, an antistatic coating film, a conductive coating film, or a hard coat layer.

A laminate having the coating film of the embodiment of the present invention and a base material can be used as, for example, an optical film such as a protective film for a polarizing plate; an electronic element; or the like. Examples of the base material include the same ones as described above.

Furthermore, examples of uses of the optical film include a polarizing plate having a polarizing film and the optical film as a protective film for a polarizing plate, on at least one or both of two protective films that protect the polarizing film. The polarizing film is not particularly limited. Examples of the other protective films include an antireflection film.

The optical film or the polarizing plate can be suitably used in, for example, for image display devices such as a liquid crystal display device (LCD), a plasma display panel (PDP), an electroluminescence display device (ELD), and a cathode ray tube display device (CRT).

### EXAMPLES

Hereinafter, the present invention will be specifically described with reference to Examples. However, the present invention is not limited thereto.

<Synthesis of Polyfunctional (Meth)Acrylamide Compound>

### Synthesis Example of Compound A

First, 30 g of N-(2-aminoethyl)-1,3-propanediamine (manufactured by Aldrich), 301 g of NaHCO₃ (4.7 equivalents with respect to one —NH₂ group contained in N-(2-aminoethyl)-1,3-propanediamine), 1 L of dichloromethane, and 50 mL of water were put into a 3-neck flask with a capacity of 2 L, comprising a stirrer, and the 3-neck flask was placed in an ice bath. Next, 232 g of acrylic acid chloride (3.3 equivalents with respect to one —NH₂ group, manufactured by Wako Pure Chemical Industries, Ltd.) was added dropwise to the 3-neck flask for 3 hours and then stirred at room temperature for 3 hours. After confirming the loss of the raw materials by proton-nuclear magnetic resonance (¹H-NMR), the solvent was distilled off from the reaction mixture under reduced pressure, and the obtained reaction mixture was dried with magnesium sulfate. Next, the reaction mixture was filtered over Celite, the filtrate was recovered, and then the solvent was distilled off from the filtrate under reduced pressure. Lastly, the obtained residue was purified by silica column chromatography (ethyl acetate/methanol=9/1 (volume ratio)) to obtain a compound A having the following structure (yield of 43%).

In addition, the structures of the compounds B to E were specifically described with reference to the respective components which will be described later.

### Synthesis Example of Compound B

By performing preparation in the same method as in Synthesis Example of Compound A, except that N-(2-aminoethyl)-1,3-propanediamine was replaced by 30 g of bis(3-aminopropyl)amine (manufactured by Tokyo Chemical Industry Co., Ltd.), a compound B having the following structure (yield of 43%) was obtained.

### Synthesis Example of Compound C

By performing preparation in the same method as in Synthesis Example of Compound A, except that N-(2-aminoethyl)-1,3-propanediamine was replaced by 30 g of N,N′-bis(3-aminopropyl)ethylenediamine (manufactured by Tokyo Chemical Industry Co., Ltd.), a compound C having the following structure (yield of 40%) was obtained.

### Synthesis Example of Compound D

By performing preparation in the same method as in Synthesis Example of Compound A, except that N-(2-aminoethyl)-1,3-propanediamine was replaced by 30 g of N,N′-bis(2-aminoethyl)-1,3-propanediamine (manufactured by Tokyo Chemical Industry Co., Ltd.), a compound D having the following structure (yield of 41%) was obtained.

### Synthesis Example of Compound E

By performing preparation by the same method as in Synthesis Example of Compound A, except that N-(2-aminoethyl)-1,3-propanediamine was replaced by 30 g of diethylene glycol bis(3-aminopropyl)ether (manufactured by Tokyo Chemical Industry Co., Ltd.), a compound E having the following structure (yield of 41%) was obtained.

### Synthesis Example of Comparative Compound

Comparative Compound A

By performing preparation by the same method as in the description in Example 1 of JP2007-031372A, a comparative compound A having the following structure (ditrimethylolpropane tetraacrylamide, yield of 50%) was obtained.

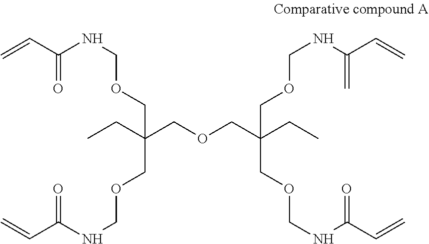 [SMILES: C=CC(=C)NCOCC(CC)(COCNC(=O)C=C)COCC(CC)(COCNC(=O)C=C)COCNC(=O)C=C]

Comparative Compound B

By performing preparation by the same method as in Synthesis Example of Compound A, except that N-(2-aminoethyl)-1,3-propanediamine was replaced by 30 g of 1,3-propanediamine (manufactured by Tokyo Chemical Industry Co., Ltd.), a comparative compound B having the following structure (N,N′-propylene bisacrylamide, yield of 45%) was obtained.

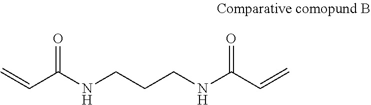

<Production of Curable Composition>

The respective components shown in Table 1 were used at a composition (parts by mass) shown in the same table and mixed with a stirrer to produce a curable composition.

Furthermore, in the section of the π-conjugated polymer A and the section of the π-conjugated polymer B in Table 1, three numerical values are described in each of the sections. In the three numerical values, the upper numerical value is the total amount of the π-conjugated polymer solution used, the intermediate numerical value is the amount of the π-conjugated polymer itself included in the π-conjugated polymer solution, and the lower numerical value is the amount of the organic solvent included in the π-conjugated polymer solution.

In addition, in the section of the blending ratio in Table 1, three numerical values are described. In the three numerical values, the upper numerical value is the total solid content, the intermediate numerical value is the total amount of each composition, and the lower numerical value is the total solid content (% by mass) with respect to the total amount of the composition.

<Manufacture of Coating Film>

Curing with Ultraviolet Ray

In Examples 1 to 8 and Comparative Examples 1 to 3, each of the curable compositions produced as above was applied onto the easy-adhesion treated surface of an easily adhesive (polyethylene terephthalate (PET), manufactured by Toyobo Co., Ltd.: COSMOSHINE A4100) film using a bar coater, and exposed with ultraviolet rays (UV) at 2 J/cm² under the condition of 25° C. to manufacture a coating film (film thickness of 10 μm) (before thermal aging).

Thermosetting

In Example 9, the curable composition produced as above was applied on the easy-adhesion treated surface of an easily adhesive PET film using a bar coater, and heated under the condition of 80° C. for 4 hours to manufacture a coating film (film thickness of 10 μm) (before thermal aging).

<Composition Solubility>

The curable composition produced as above (before thermal aging) was visually observed immediately after the production, and the uniformity of the composition was confirmed.

A case where the composition is entirely uniform without separation was indicated to as “1 Layer”.

A case where the composition was separated into two layers and white turbidity was slightly observed was indicated as “Slight Separation into 2 Layers”.

A case where the composition was separated into two layers and clear white turbidity was observed in the entire liquid was indicated as “Separation into 2 Layers”.

<Evaluation of Antistatic Properties>

Each of the coating films obtained as above (before thermal aging) was cut in size of 10 cm vertical×0 cm horizontal to manufacture a sample, and the sample was left to stand in an atmosphere at a temperature of 25° C. and a relative humidity of 40% for 24 hours. Thereafter, a surface resistivity (Ω/□) after one minute from the application of a voltage was measured (temperature: 25° C., relative humidity: 40%, and applied voltage: 100 V), using a surface resistance measuring device (SME-8310 manufactured by TOA Electronics, Inc.), and evaluated according to the following standard. A or B is preferable.
A: The common logarithm (log SR) of the surface resistivity is less than 11.
B: The log SR is 11 or more to less than 12.
C: The log SR 12 or more.

<Evaluation of Film Hardness>

The pencil hardness of each of the coating films obtained as above (before thermal aging) was measured in accordance with the test method shown in JIS K5401 and evaluated according to the following standard. A or B is preferable.
A: The pencil hardness was 2 H or more.
B: The pencil hardness was H.
C: The pencil hardness was F or less.

<Evaluation after Thermal Aging>

Each of the coating films obtained as above (before thermal aging) was left to stand under the conditions of 80° C. and 24 hours to obtain a coating film after thermal aging. Using each of the coating films after thermal aging, obtained as above, the surface resistivity and the pencil hardness were measured in the same manner as in <Evaluation of Antistatic Properties> and <Evaluation of Film Hardness>, and evaluated according to the following standard.

TABLE 1

| | Compositional composition | | | | | | | | | | | | | | | | |
|---|---|---|---|---|---|---|---|---|---|---|---|---|---|---|---|---|---|
| | | | | | | | | π-Con- | π-Con- | | | | | | | | |
| | | | | | | | | jugated | jugated | | | | | | | | |
| | | | | | | | | polymer | polymer | | | | | | | | |
| | | | | | | | | A (0.8% | B (0.7% | | | | | | | | |
| | | | | | | | | by mass | by mass | | | | | | | | |
| | | | | | | | | solution) | solution) | | | Blending ratio | | | | | |
| | | | | | | | | Upper: Total | | | | Upper: Total | | | | | |
| | | | | | | | | amount (parts | | | | solid content | | | | | |
| | | | | | | | | by mass) of | | | | (parts by mass) | | | | | |
| | | | | | | | | π-conjugated | | | | Intermediate: | | | | | |
| | | | | | | | | polymer solution | | | | Total | | | | | |
| | | | | | | | | Intermediate: | | | | amount (parts | | Physical properties of film | | | |
| | Polyfunctional (meth)acrylamide compound | | | | | | | Amount (parts by | | | | by mass) of | | Antistatic | | Film | |
| | | | | | | Com- | Com- | mass) of π- | | | | composition | | properties | | hardness | |
| | | | | | | par- | par- | conjugated | | Photo- | Thermal | Lower: Total | | (surface | | (pencil | |
| | | | | | | ative | ative | polymer itself | | polymer- | polymer- | solid content to | | resistance) | | hardness) | |
| | | | | | | com- | com- | Lower: Amount | | ization | ization | total amount of | Compo- | Before | After | Before | After |
| | Compound | Compound | Compound | Compound | Compound | pound | pound | parts by mass) of | | Initiator | Initiator | composition | sition | thermal | thermal | thermal | thermal |
| | A | B | C | D | E | A | B | organic solvent | | (Irg 184) | (V-601) | (% by mass) | solubility | aging | aging | aging | aging |
| Example 1 | 87 | | | | | | | 1,250 | | 3 | | 100 parts by mass | 1 Layer | A | A | A | A |
| | | | | | | | | (10) | | | | 1340 parts by mass | | | | | |
| | | | | | | | | ((1,240)) | | | | 7.5% by mass | | | | | |
| Example 2 | | 87 | | | | | | 1,250 | | 3 | | 100 parts by mass | 1 Layer | A | A | A | A |
| | | | | | | | | (10) | | | | 1340 parts by mass | | | | | |
| | | | | | | | | ((1,240)) | | | | 7.5% by mass | | | | | |
| Example 3 | | | 87 | | | | | 1,250 | | 3 | | 100 parts by mass | 1 Layer | A | A | A | A |
| | | | | | | | | (10) | | | | 1340 parts by mass | | | | | |
| | | | | | | | | ((1,240) | | | | 7.5% by mass | | | | | |
| Example 4 | | | | 87 | | | | 1,250 | | 3 | | 100 parts by mass | 1 Layer | A | A | A | A |
| | | | | | | | | (10) | | | | 1340 parts by mass | | | | | |
| | | | | | | | | ((1,240)) | | | | 7.5% by mass | | | | | |
| Example 5 | | | | | 87 | | | 1,250 | | 3 | | 100 parts by mass | Slight | B | B | B | B |
| | | | | | | | | (10) | | | | 1340 parts by mass | separation | | | | |
| | | | | | | | | ((1,240)) | | | | 7.5% by mass | into 2 | | | | |
| | | | | | | | | | | | | | layers | | | | |
| Example 6 | 70 | | | | | | | 3,375 | | 3 | | 100 parts by mass | 1 Layer | A | A | A | A |
| | | | | | | | | (27) | | | | 3448 parts by mass | | | | | |
| | | | | | | | | ((3,348)) | | | | 2.9% by mass | | | | | |
| Example 7 | 49 | | | | | | | 6,000 | | 3 | | 100 parts by mass | 1 Layer | A | A | B | B |
| | | | | | | | | (48) | | | | 6052 parts by mass | | | | | |
| | | | | | | | | ((5,952)) | | | | 1.7% by mass | | | | | |
| Example 8 | 87 | | | | | | | | 1,429 | 3 | | 100 parts by mass | 1 Layer | A | A | A | A |
| | | | | | | | | | (10) | | | 1519 parts by mass | | | | | |
| | | | | | | | | | ((1,419)) | | | 6.5% by mass | | | | | |
| Example 9 | 87 | | | | | | | 1,250 | | | 3 | 100 parts by mass | 1 Layer | A | A | A | A |
| | | | | | | | | (10) | | | | 1340 parts by mass | | | | | |
| | | | | | | | | ((1,240)) | | | | 7.5% by mass | | | | | |
| Compar- | 97 | | | | | | | | | 3 | | 100 parts by mass | 1 Layer | C | C | A | A |
| ative | | | | | | | | | | | | 100 parts by mass | | | | | |
| Example 1 | | | | | | | | | | | | 100% by mass | | | | | |
| Compar- | | | | | | 87 | | 1,250 | | 3 | | 100 parts by mass | Slight | B | C | B | C |
| ative | | | | | | | | (10) | | | | 1340 parts by mass | separation | | | | |
| Example 2 | | | | | | | | ((1,240)) | | | | 7.5% by mass | into 2 | | | | |
| | | | | | | | | | | | | | layers | | | | |
| Compar- | | | | | | | 87 | 1,250 | | 3 | | 100 parts by mass | Slight | C | C | C | C |
| ative | | | | | | | | (10) | | | | 1340 parts by mass | separation | | | | |
| Example 3 | | | | | | | | ((1,240)) | | | | 7.5% by mass | into 2 | | | | |
| | | | | | | | | | | | | | layers | | | | |

Details of the respective components shown in Table 1 are as follows.

Polyfunctional (meth)acrylamide compound: The compounds A to E and the comparative compounds A to B, synthesized as above, were used. The structures of the respective compounds are shown below. The compounds A to D are liquid at room temperature. The compound E is solid at room temperature. Further, the blank sections in the table indicate that none of compounds are included.

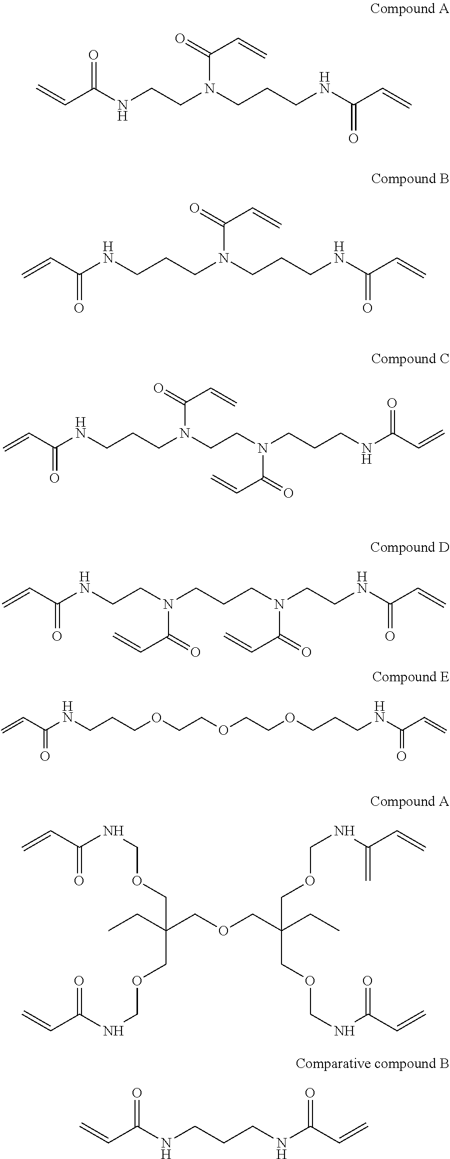

π-Conjugated polymer A (0.8% by mass solution): Aedotron C3-PC (manufactured by Aldrich, Product No. 736287, 0.8% by mass of a propylene carbonate solution. Polymerization pattern: C₁₂—PEG-block-PEDOT-block-PEG-C₁₂, dopant: perchlorate

π-Conjugated polymer B (0.7% by mass solution): Aedotron P3-NM (manufactured by Aldrich, Product No. 736295, 0.7% by mass of a nitromethane solution). Polymerization pattern: C₁₂-PEG-block-PEDOT-block-PEG-C₁₂, dopant: p-toluenesulfonate, the formula has the following structural formula.

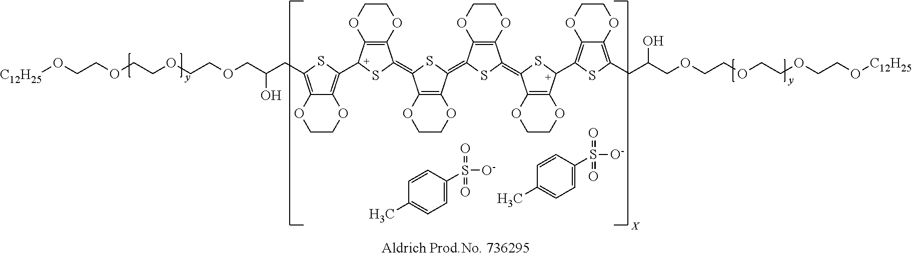

Photopolymerization initiator (Irg. 184): IRGACURE 184 (manufactured by BASF)

Thermal polymerization initiator (V-601): V-601 (azo-based thermal initiator to be dissolved in an organic solvent) (manufactured by Wako Pure Chemical Industries, Ltd.)

As clearly seen from the results in Table 1, in Comparative Example 1 not containing the π-conjugated polymer, the antistatic properties were poor both before heating and after heating.

In Comparative Example 2 not containing the specific compound, but containing ditrimethylolpropane tetraacrylamide instead, the film hardness and the antistatic properties before heating could not be maintained after heating.

In addition, in Comparative Example 3 not containing the specific compound, but containing N,N′-propylene bisacrylamide instead, the film hardness and the antistatic properties were poor both before heating and after heating.

In contrast, in Examples 1 to 9, it was possible to satisfy both excellent film hardness and excellent antistatic properties, and maintain the film hardness and the antistatic properties before and after heating.

In comparison between Examples 1 to 4 and Example 5, in Examples 1 to 4 containing the polyfunctional (meth)acrylamide compound which is liquid at room temperature, the antistatic properties and the film hardness were more excellent than in Example 5 containing the polyfunctional (meth)acrylamide compound which is solid at room temperature.

In comparison between Examples 1 and 6 and Example 7, in Examples 1 and 6 in which the content of the polyfunctional (meth)acrylamide compound was higher, the film hardness was more excellent than in Example 7 in which the content of the polyfunctional (meth)acrylamide compound was low.

What is claimed is:

1. A curable composition comprising:
at least one polyfunctional compound selected from the group consisting of a compound represented by General Formula (I) and a compound represented by General Formula (II);
a π-conjugated polymer; and
an organic solvent,
wherein the π-conjugated polymer is a block copolymer, 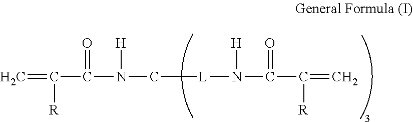
in General Formula (I), R's each independently represent a hydrogen atom or a methyl group, and
L's each independently represent —O—, an alkylene group having 2 to 4 carbon atoms, or a divalent linking group formed by combination thereof, 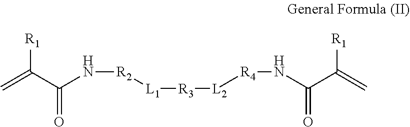
in General Formula (II), R₁'s each independently represent a hydrogen atom or a methyl group,
R₂ and R₄ each independently represent —O—, an alkylene group having 1 to 4 carbon atoms, or a divalent linking group formed by combination thereof,
R₃ represents —O—, an alkylene group having 2 to 4 carbon atoms, a group represented by General Formula (III), or a divalent linking group formed by combination thereof, and
L₁ and L₂ each independently represent a single bond or a group represented by General Formula (III), 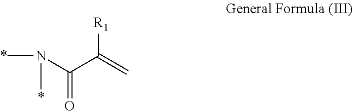
in General Formula (III), R₁ represents a hydrogen atom or a methyl group, and * represents a bonding position.

2. The curable composition according to claim 1,
wherein the block copolymer has a block X of a π-conjugated polymer and a block Y of a polyoxyalkylene.

3. The curable composition according to claim 2,
wherein the block copolymer is a block copolymer having one or plural units represented by the block X-the block Y, or a triblock copolymer represented by the block Y-the block X-the block Y.

4. The curable composition according to claim 2,
wherein the block Y is at least one selected from polyethylene glycol or polypropylene glycol.

5. The curable composition according to claim 3,
wherein the block Y is at least one selected from polyethylene glycol or polypropylene glycol.

6. The curable composition according to claim 2,
wherein a terminal of the block Y is an alkyloxy group.

7. The curable composition according to claim 3,
wherein a terminal of the block Y is an alkyloxy group.

8. The curable composition according to claim 4,
wherein a terminal of the block Y is an alkyloxy group.

9. The curable composition according to claim 5,
wherein a terminal of the block Y is an alkyloxy group.

10. The curable composition according to claim 2,
wherein the block X is a doped poly(3,4-ethylenedioxythiophene).

11. The curable composition according to claim 3,
wherein the block X is a doped poly(3,4-ethylenedioxythiophene).

12. The curable composition according to claim 4,
wherein the block X is a doped poly(3,4-ethylenedioxythiophene).

13. The curable composition according to claim 5,
wherein the block X is a doped poly(3,4-ethylenedioxythiophene).

14. The curable composition according to claim 1,
wherein the organic solvent is at least one selected from the group consisting of propylene carbonate, nitromethane, and dichlorobenzene.

15. The curable composition according to claim 1,
wherein the polyfunctional compound is at least one selected from the group consisting of the following compound A, compound B, compound C, and compound D.

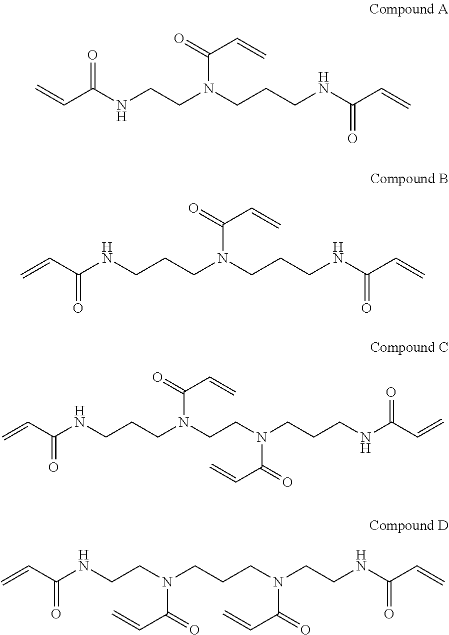

16. The curable composition according to claim 1, further comprising an initiator.

17. The curable composition according to claim 16,
wherein the content of the polyfunctional compound is 50% to 90% by mass with respect to the total solid content.

18. The curable composition according to claim 1,
wherein the compound represented by General Formula (II) is a compound except
when —O— is adjacent to the group represented by General Formula (III),
when the groups represented by General Formula (III) are adjacent to each other, or
when —O— is adjacent to each other.

19. A coating film formed by curing the curable composition according to claim 1.
